(19) United States
(12) Patent Application Publication
(10) Pub. No.: US 2003/0236113 A1
(43) Pub. Date: Dec. 25, 2003

(54) Game playing apparatus

(75) Inventor: Derek J. Webb, Derby (GB)

Correspondence Address: NIXON & VANDERHYE, PC, 1100 N GLEBE ROAD, 8TH FLOOR, ARLINGTON, VA, 22201-4714, US

(73) Assignee: Prime Table Games LLC, Las Vegas, NV

(21) Appl. No.: 10/447,262

(22) Filed: May 29, 2003

(30) Foreign Application Priority Data
May 30, 2002 (GB) 0212498.0

(51) Int. Cl. G06F 17/00; G06F 19/00

(52) U.S. Cl. 463/11

(57) ABSTRACT

Game playing apparatus has a playing structure 12 onto which cards may be dealt by a dealer standing at 14. The table 12 incorporates a plurality of imaging devices 16, such as one for each player. Each device 16 has a player terminal 18 to which it is connected at 20. Each imaging device 16 creates an image signal representative of a card dealt onto to the table 12. The image signal is sent to the corresponding terminal 18 to display an image viewable by the corresponding player. User controls allow the player to interact with the terminal 18 in order to take part in the game.

The present invention relates to game playing apparatus and in particular, to apparatus for playing card games.

Many card games can be used for gambling. Consequently, facilities for playing card games are often provided by casinos and other gaming establishments. Commonly, players will sit around a playing surface such as a table, and the game will be run by a casino staff member acting as dealer. The dealer will control the running of the game, including the placing of bets by the players, and pay-outs in accordance with the rules of the game.

Many card games have a limit on the number of players who can play, arising from the number of playing cards in a standard pack, the size of hands etc. This limits the number of players served by a single dealer and accordingly, in order to make the game commercially acceptable for the casino, it is common to require all bets to exceed a minimum value set by the house. High minimum bets can deter potential players from participating, particularly new players, who may feel they are not sufficiently familiar with the game being played.

The present invention provides game playing apparatus comprising a playing structure onto which cards may be dealt, at least one imaging device operable to create an image signal representative of a dealt card, and at least one player terminal in communication with the image device and operable to display an image in response to an image signal received from the imaging device, the player terminal being further operable to receive player decisions relating to the game being played, whereby a player may play the game by viewing and operating the player terminal.

The apparatus according to the invention allows a single dealer to service a larger number of players, to the commercial advantage of the house, as will be described.

Preferably the playing structure is a surface onto which cards may be dealt. There may be a plurality of regions on the structure onto which cards may be dealt. The or each region preferably has a respective imaging device associated therewith, to create an image signal representative only of a card or cards dealt onto the corresponding region.

There may be a single player terminal associated with each region, whereby each player may use a respective terminal to play a respective hand. Alternatively, there may be a plurality of player terminals associated with the or at least one of the regions whereby a plurality of players may use respective player terminals to play the same hand independently of each other.

The or each imaging device is preferably located to view the face of a card placed face down on the playing structure. The or at least one of the imaging devices may be associated with a transparent region of the player structure, to view the card face through the transparent region. The or at least one of the imaging devices may be operable to detect the identity of a dealt card and to create an image signal in response to the identity detected. The imaging device may be operable to detect machine readable information carried by the card. The machine readable information may be a bar code. The machine readable information may be information readable by non-optical means, such as a magnetic sensor, inductive coupling or the like.

Alternatively the player terminal may display a live video image received from the or the corresponding imaging device. The player terminal may be operable to receive an image signal identifying one or more cards and to create an image representing those cards for viewing by the player.

The player terminal preferably has control means operable by a player to place bets relating to the game being played. The player terminal may have control means operable to send instructions for playing the card or cards being viewed.

Preferably the apparatus maintains a credit score for the or each player, the score being incremented by winnings and decremented by stakes bet by a player. The apparatus may record bets placed by a player and further comprise a bet resolution arrangement operable to resolve bets in accordance with the rules of the game being played. There may be further dealer control means operable by a dealer to send a signal to the or each player terminal to authorise the or each bet resolution arrangement to resolve bets.

Preferably the apparatus is operable to detect the identity of the or each dealt card and to provide the bet resolution arrangement with information relating to the detected identity. The identity may be detected by detecting machine readable information carried by the card. The machine readable information may be readable by the imaging device. Alternatively, the apparatus may incorporate image recognition means operable to detect the identity of a card by an image recognition process.

There may be a further imaging device associated with the dealer and operable to create an image signal representative of a card dealt to the dealer. The apparatus may comprise control means operable to provide the dealer image signal to the or each player terminal when a dealer hand is to be revealed to one or more other players in accordance with the rules of the game being played, the or each player terminal being operable in response to a dealer image signal to display an image of the dealer card or cards to the player operating the terminal. The or each player terminal may communicate with the or an imaging device by means of a communication network, which may be public or private, such as the internet or an intranet.

The invention also provides game playing apparatus comprising a playing structure onto which cards may be dealt, and at least one imaging device operable to create an image signal representative of a dealt card, and further operable to send the image signal for receipt by a player terminal.

Preferably the playing structure is a surface onto which cards may be dealt. There may be a plurality of regions on the structure onto which cards may be dealt. The or each region preferably has a respective imaging device associated therewith, to create an image signal representative only of a card or cards dealt onto the corresponding region.

The or each imaging device is preferably located to view the face of a card placed face down on the playing structure. The or at least one of the imaging devices may be associated with a transparent region of the player structure, to view the card face through the transparent region. The or at least one of the imaging devices may be operable to detect the identity of a dealt card and to create an image signal in response to the identity detected. The imaging device may be operable to detect machine readable information carried by the card. The machine readable information may be a bar code. The machine readable information may be information readable by non-optical means, such as a magnetic sensor, inductive coupling or the like.

Preferably the apparatus maintains a credit score for the or each player, the score being incremented by winnings and decremented by stakes bet by a player. The apparatus may record bets placed by a player and further comprise a bet resolution arrangement operable to resolve bets in accordance with the rules of the game being played.

Preferably the apparatus is operable to detect the identity of the or each dealt card and to provide the bet resolution arrangement with information relating to the detected identity. The identity may be detected by detecting machine readable information carried by the card. The machine readable information may be readable by the imaging device. Alternatively, the apparatus may incorporate image recognition means operable to detect the identity of a card by an image recognition process.

There may be a further imaging device associated with the dealer and operable to create an image signal representative of a card dealt to the dealer. The apparatus may comprise control means operable to provide the dealer image signal to a player terminal when a dealer hand is to be revealed to a player in accordance with the rules of the game being played. The apparatus may be operable to send image signals by means of a communication network such as the internet.

The invention also provides a player terminal for use in game playing, the terminal being operable to receive an image signal representative of a card dealt in a card game and operable to display an image in response to the image signal for viewing by the player, the player terminal being further operable to receive player decisions relating to the game being played, whereby the player may play the game by viewing and operating the player terminal.

The player terminal may display a live video image received from the or the corresponding imaging device. The player terminal may be operable to receive an image signal identifying one or more cards and to create an image representing those cards for viewing by the player.

The player terminal preferably has control means operable by a player to place bets relating to the game being played. The player terminal may have control means operable to send instructions for playing the card or cards being viewed.

Preferably the apparatus maintains a credit score for the or each player, the score being incremented by winnings and decremented by stakes bet by a player. The apparatus may record bets placed by a player and further comprise a bet resolution arrangement operable to resolve bets in accordance with the rules of the game being played.

Preferably the apparatus is operable to detect the identity of the or each dealt card and to provide the bet resolution arrangement with information relating to the detected identity. The apparatus may incorporate image recognition means operable to detect the identity of a card by an image recognition process.

The player terminal may be further operable to receive an image signal representative of a card dealt to a dealer. The or each player terminal may communicate with the or an imaging device by means of a communication network such as the internet.

Preferably the player terminal is a computer programmed to operate as aforesaid.

The invention also provides computer software which, when installed on a computer system, is operable to provide a player terminal operable as set out above.

The invention also provides a method of operating a computer in order to participate in a card game, including:

(i) causing the computer to receive an image signal representative of a card dealt in the card game;

(ii) creating a screen image of the dealt card for viewing by a player;

(iii) responding to instructions input by the user to identify player decisions relating to the game being played.

The invention also provides computer software which, when installed on a computer system, is operable to cause the computer to implement the method aforesaid.

The invention also provides a method of providing a card game for play by players, including:

(i) providing a playing structure onto which cards may be dealt and having at least one imaging device operable to create an image signal representative of a dealt card;

(ii) dealing at least one card onto the playing structure;

(iii) operating the imaging device to provide an image signal; and

(iv) sending the image signal for receipt at a player terminal for use in displaying an image for viewing by a player.

Preferably the playing structure is a playing structure as defined above.

Examples of apparatus according to the present invention, and their method of use in accordance with the invention, will now be described in more detail, by way of example only, and with reference to the accompanying drawings, in which:

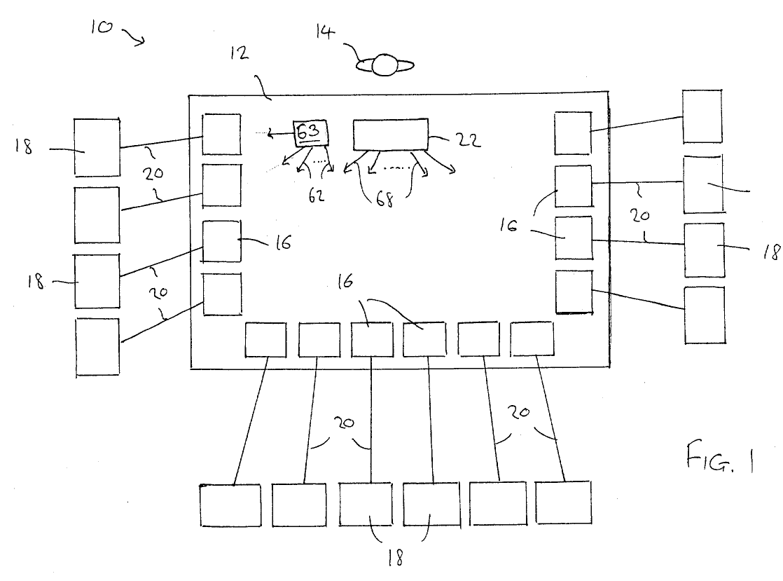

FIG. 1 is a highly schematic overview of a first embodiment of the present invention;

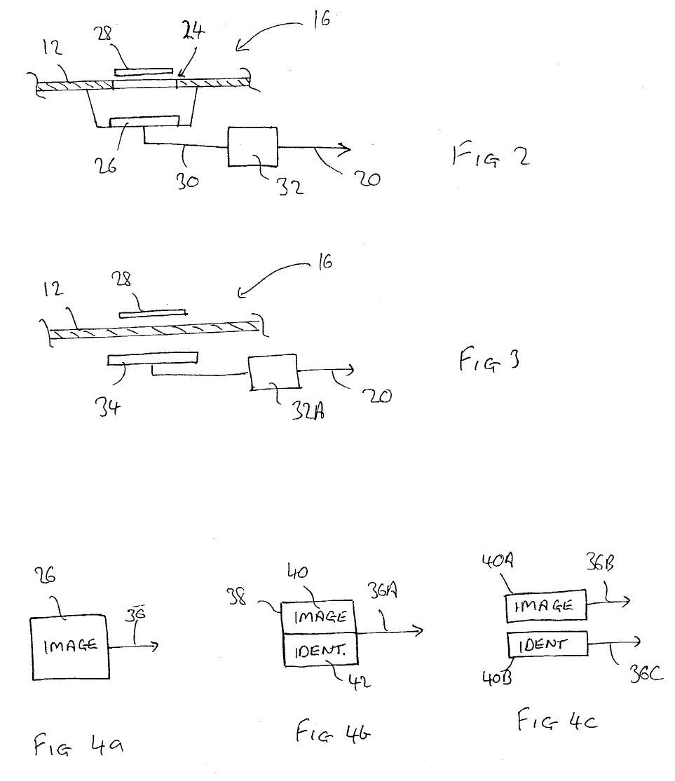

FIGS. 2 and 3 are partial sections through the playing surface of FIG. 1, schematically illustrating alternative arrangements;

FIGS. 4a, 4b and 4c illustrate in simplified block diagram form three alternative arrangements for using the apparatus of FIGS. 2 and 3;

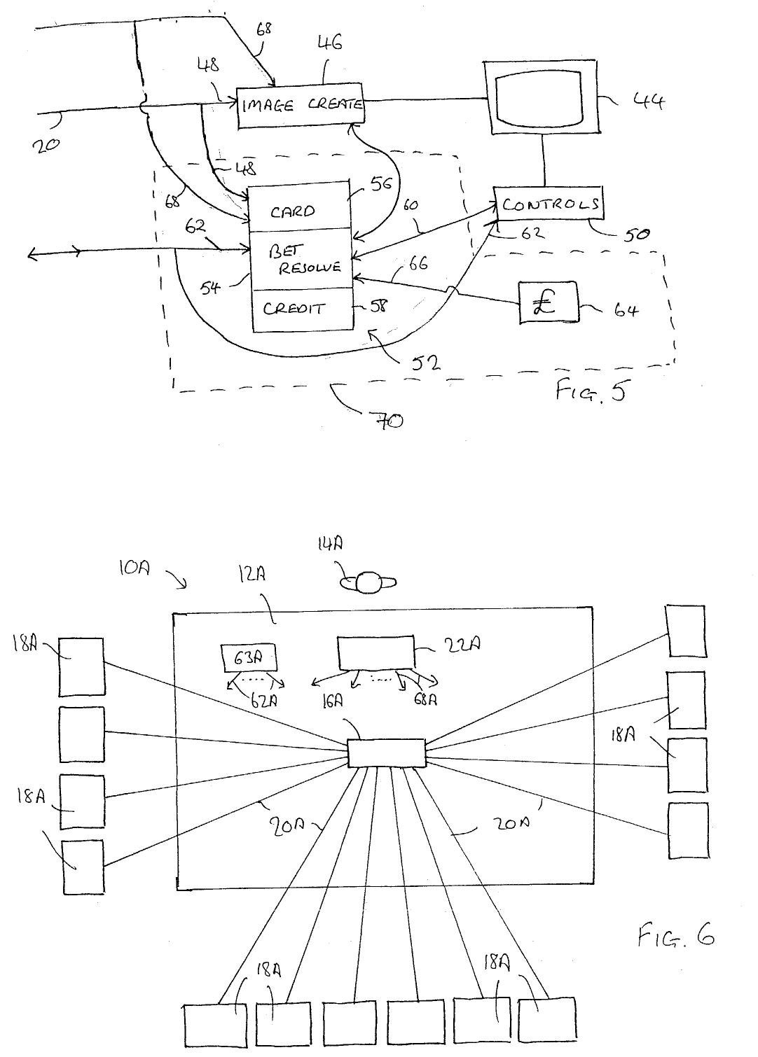

FIG. 5 is a block diagram of a player terminal for use in accordance with the invention; and

FIG. 6 illustrates an alternative embodiment of the invention, into which the structures of FIGS. 2 to 5 may be incorporated.

Overview

FIG. 1 illustrates game playing apparatus 10 which has a playing structure 12 onto which cards may be dealt by a dealer standing at 14. The structure 12 is preferably designed to resemble a conventional table on which a card game is played. This, together with the use of a human dealer 14 to deal real cards onto the table 12 results in the card game being played as a live game, which improves the playing experience of players.

The table 12 incorporates a plurality of imaging devices 16. In this example, one imaging device 16 is provided for each player and thus, the number of devices 16 corresponds with the maximum number of players who can play simultaneously. Each imaging device 16 has an associated player terminal 18 to which it is connected at 20. An alternative arrangement will be described later, with reference to FIG. 6.

The structure 12 also includes a further imaging device 22, here called the dealer imaging device.

Each of the imaging devices 16 is arranged to create an image signal representative of a card dealt onto the table 12 by the dealer 14. This image signal is sent to the corresponding player terminal 18, which uses the image signal to display an image representing the dealt card and viewable by the player using that particular player terminal 18. The player can interact with the terminal 18 in order to take part in the game and in response to the image viewed by the player. In particular, the player may use the terminal to place bets during the game.

Playing Surface and Imaging Devices

FIGS. 2 and 3 illustrate two configurations of imaging devices (indicated generally as 16) which can be used to create an image signal representative of a dealt card.

In FIG. 2, the table 12 has a window 24 of transparent material, such as glass, set into the surface. A device 26, such as a camera, is mounted below the window 24. Consequently, a card 28 placed on the window 24 can be viewed by the camera 26. In particular, the face of a card 28 can be viewed by the camera 26 when the card is placed face down on the window 24.

The camera 26 has an output 30 which provides a signal representative of the image seen by the camera 26 and thus, representative of the face of the card 28 when placed face down on the window 24. The output 30 passes through a control arrangement 32 to the connection 20 to the player terminal 18.

The camera 28 and control arrangement 32 may be arranged to create a video signal of the view from a position of the camera 26, this video signal being sent to the player terminal for creating a screen image by which the player may remotely view the card 28.

Alternatively, or in addition, the image signal on the connection 20 may include information which identifies the card which the camera 26 is viewing. For example, the control arrangement 32 may incorporate image recognition software similar to that now commonly used for optical character recognition in document scanning systems, arranged to identify the card 28 by analysis of the video output from the camera 26, for instance by comparison with a template of standard images of playing cards. The image recognition process will be required to provide accurate recognition of any card from a standard pack of playing cards, regardless of the precise position and orientation with which the card 28 is laid onto the window 24, and preferably to recognise each card in the event that several cards (a “hand”) is dealt onto the window 24.

A simpler arrangement for recognising the dealt card could be provided by providing machine readable information on each card, such as a bar code. The control arrangement 32 can then be arranged to scan the image to look for a bar code, to read the bar code and thus to identify the card 28.

FIG. 3 illustrates an alternative arrangement for recognising a card. In this example, the table 12 is not interrupted by a window. A detector 34 is located beneath the table 12, under the region of the table 12 on which cards 28 are to be dealt. In this example, the cards will be modified from a conventional pack, in order to carry information identifying each card, this information being in a form which is machine readable but non-optical. For example, magnetic material could be incorporated within the card 28, or induction loop arrangements could be incorporated within the card 28, by means of which the detector 34 may interrogate the card in order to establish its identity. The output of the detector 34 is applied to a control arrangement 32A for creating an image signal at the connection 20, to be sent to the terminal 18. Consequently, the arrangements of FIGS. 2 and 3 allow two different responses to be made to the dealing of a card. The camera 26 allows a video signal to be created, allowing remote viewing of a live image of the card 28. In addition, image recognition, bar code reading or non-optical interrogation of the card allow the identity of the card to be established. Consequently, the connection 20 can be used to send to the player terminal 18 either

(i) a live image of the card 28, without any interpretation as to the identity of the card;

(ii) a signal indicating the identity of the card, but not incorporating a live video image; or

(iii) a live video signal, together with information identifying the card being viewed.

These three alternatives are schematically illustrated in FIGS. 4a, 4b and 4c. FIG. 4a illustrates a single device (the camera 26) creating a signal 36, representing the image (option i above). FIG. 4b illustrates a single device 38 which independently creates an image at 40 and identification at 42 to provide a single signal 36A incorporating all of this information. FIG. 4c illustrates two devices 40A, 40B which, respectively, create an image signal 36B and an identification signal 36C.

Player Terminal

FIG. 5 illustrates the structure of a player terminal to which image signals are sent over a connection 20, created as described above.

Some of the functions to be described in the player terminal 18 can alternatively be provided at the structure 12, for example by operation of the control arrangements 32, 32A. These alternatives will be set out more fully below.

The player terminal 18 includes a screen 44 on which an image may be created by an image creation arrangement 46, which may be a conventional arrangement for creating a video image on a computer or television screen 44. The image creation device 46 receives an image signal at 48 over the connection 20, created as described above in relation to FIGS. 2 to 4.

In the event that the image signal 48 is a video signal representing the view of the camera 26, the arrangement 46 creates a live image on the screen 44, giving the player viewing the screen 44 a live view of the cards being dealt.

Alternatively, the image signal 48 may consist of information which identifies the card which has been dealt, but does not itself carry video information representing an image of the card. In that event, the image creation arrangement 46 will create on the screen 44 an image which represents the card identified by the signal 48. This gives a screen image which is less realistic and may thus be considered less desirable by players or casino owners.

The terminal 18 also has player controls 50 by which the player may notify the apparatus of decisions relating to the game being played. In particular, the controls 50 allow bets to be placed by the player, in response to images viewed on the screen 44 and in accordance with the rules of the game being played. The controls 50 may be buttons or other mechanical controls, or regions of a touch sensitive screen, for example.

A bet arrangement 52 is provided, including a bet resolution module 54 and associated with a card identification module 56 and a credit module 58.

The bet resolution module 54 receives input at 60 from the controls 50 to identify bets being placed. The card identification module 56 receives all or part of the image signal 48 in order to identify to the bet resolution module 54 the card or cards which have been dealt to that player at the corresponding imaging device 16. Taking into account the three options set out above for the content of the image signal 48, the card identification module 56 may be operable either to:

(i) apply an image recognition process to the video signal in order to recognise the card or cards which have been dealt and to provide this identification to the bet resolution module 54;

(ii) read the card identification information contained in the image signal 48 in order to identify the card or cards to the bet resolution module 54; or

(iii) identify the card identity information within the image signal 48, ignoring the video content, and then to function as at ii above.

The bet resolution module 54 is therefore provided with information about bets placed by the player, and also with information about the cards dealt. Operating in accordance with the predetermined rules of the game, the bet resolution module 54 can therefore decide if the player has won or lost, and award winnings according to the odds and the stake. The bet resolution module 54 provides signals to the image creation arrangement 46 so that the image on the screen 44 can incorporate appropriate information for the player, such as the current level of credit, the current bets which have been placed, and details of their resolution. The credit module 58 is used to record the current state of credit of the player, taking into account any winnings credited to the player by the module 54, any stakes played by the player by operating the controls 50, these stakes being recorded by the module 54 decrementing the credit value in the credit module 58, or any further credits bought by the player by means of a financial transaction with the house. Operation of the bet resolution module 54 may be initiated automatically, for example when the module identifies, from the identified cards, that an appropriate point has been reached in the game for the resolution of bets. Alternatively, operation of the module 54 may be authorised by a signal received from the dealer or house over a connection 62, initiated by a control 63 (FIG. 1). The connection 62 may be bi-directional and also used to convey instructions from the controls 50 to the dealer control 63, for example requests from the player for the dealer 14 to deal another card to the hand being controlled by that player.

The terminal 18 may also include a payment module 64 by means of which the player can purchase additional credits in the module 58. The module 64 may be arranged to receive and verify conventional bank notes, credit cards or the like and then to communicate at 66 to the module 58 the number of additional credits to be incremented. Alternatively, the module 64 could receive tokens provided by the house in return for conventional payment, such as standard casino chips, in the manner of a coin-operated machine. The module 64 could also be arranged to pay out the winnings of the player, as determined by the current value within the credit module 58. Payment may be either by cash, credit to a credit card account or the like, casino chips or the production of a voucher to be redeemed elsewhere in the casino.

Dealer's Hand

In many casino card games, such as Three Card Poker, also known as Casino Brag, a player will initially be able to see only their own hand but, at the time for resolving bets, the dealer's hand will also be revealed. The purpose of the dealer imaging device 22 (FIG. 1) is to enable this play to be emulated.

A dealer image signal is provided at 68 to the player terminal 18. The signal 68 may be created in the same manner as, and be sent in the same manner as an image signal from one of the devices 16. However, the dealer image signal 68 will not be sent until the appropriate point has been reached in the game. The signal 68, when received, passes to the image creation arrangement 46 so that the image on the screen 44 can be augmented with an image of the dealer's hand as dealt onto the dealer imaging device 22.

Consequently, the initial stages of the game are played with the player able to see only an image of the corresponding hand on the corresponding imaging device 16, that signal being augmented on the basis of a dealer image signal 68 sent at the appropriate point at which the hand of the dealer is to be revealed.

The dealer image signal 68 is also supplied to the card identification module 56 so that the cards in the dealer hand can be identified for bet resolution by the module 54.

Alternative Player Terminal Arrangements

The components illustrated in FIG. 5 and their corresponding functions have all been described as being located within and taking place within the player terminal 18. However, some of them may be located elsewhere and in particular, may be associated with the table 12. Those components and features indicated within the box 70 in FIG. 5 could be located elsewhere (or some of them). On that basis, the terminal 18 could consist simply of the screen 44, controls 50 and image creation arrangement 46, receiving image signals 48, dealer image signals 68 and signals from the bet resolution module 54. Consequently, the player terminal 18 can be configured as a general purpose computer running under appropriate software control to receive and interpret these signals in order to create an appropriate screen image. An appropriately programmed general purpose computer could therefore be used as a player terminal 18 by receiving those signals over a public or private network such as the internet or an intranet, thus allowing a player to play a live game from a location remote from the casino. However, it is particularly preferred for players to play by means of terminals 18 located at the casino, within view of the table 12 and dealer 14, so that the full atmosphere of a live card game is available to the player.

Advantages of the Arrangement of FIG. 1

The number of players playing a single card game in a casino is normally limited, as noted above. For example, Three Card Poker is normally limited to seven players plus the dealer. Increasing the number of players above this number leads to the players being able to guess or deduce additional information which can distort the outcome of a game and thus damage the commercial viability of the game for the casino. However, the arrangement shown in FIG. 1 allows the number of players to be increased. This is because the player terminals may be located at some distance from each other and from the table, so that the players are less likely to deduce additional information and thus distort the outcome of the game. It is envisaged that as many as sixteen hands of Three Card Poker could be dealt in this manner, which would not be viable in a conventional arrangement. Consequently, the number of players being served by a single dealer is increased, making the game more profitable for the casino and allowing the minimum bet value to be reduced, thus further encouraging play.

Alternative Arrangement

FIG. 6 illustrates an alternative arrangement in which many components are the same as the corresponding components in FIG. 1 and are thus given equivalent reference numerals with the suffix A.

In FIG. 6, the apparatus 10A includes a table 12A at which a dealer 14A deals a player hand onto a single player imaging device 16A. The device 16A is connected to a large number of player terminals 18A. The number of terminals 18A is unlimited, as will become apparent.

Connections 20A provide image signals from the device 16 to all of the terminals 18A. In addition, a dealer imaging device 22A can provide a dealer image signal to each of the player terminals 18A. Each of the player terminals 18A is as described above in relation to FIG. 5.

Consequently, whereas the arrangement of FIG. 1 allowed each player to play a separate hand dealt onto a respective imaging device 16, the arrangement in FIG. 6 allows each player to play the same hand dealt onto the single imaging device 16A. Consequently, there is no upper limit on the number of players who can be accommodated in this arrangement. This improves the commercial value of a game to a casino. However, it will be apparent that this arrangement cannot be used for all types of card games. In particular, games in which there is interaction between the player and the dealer, such as requests for additional cards to be dealt, could not be played because there would be conflicts between the instructions issued by different players.

Examples of casino games which can be played with this apparatus and an unlimited number of players are games based on poker value rankings (poker, brag) or numerical value rankings (e.g. blackjack).

Modifications and Variations

It will be apparent from the above description that many variations and modifications can be made without departing from the scope of the invention. In particular, many different technologies can be used to implement the various components of the system. Many different computer architectures, program languages and the like can be used to achieve the functions described.

It will be apparent that in both alternatives described above, players can be playing simultaneously, and control of the game (particularly bet resolution) is automated. This allows games to proceed more quickly, which gives commercial benefit to the casino because a greater number of bets will be placed in a particular amount of time. Furthermore, the use of a bet resolution module to automate the calculation of winnings and pay-outs prevents house profit being lost by error or fraud.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Game playing apparatus comprising a playing structure onto which cards may be dealt, at least one imaging device operable to create an image signal representative of a dealt card, and at least one player terminal in communication with the image device and operable to display an image in response to an image signal received from the imaging device, the player terminal being further operable to receive player decisions relating to the game being played, whereby a player may play the game by viewing and operating the player terminal.

2. Apparatus according to claim 1, wherein the playing structure is a surface onto which cards may be dealt.

3. Apparatus according to claim 2, wherein a plurality of regions are provided on the structure, onto which cards may be dealt.

4. Apparatus according to claim 3, wherein each region has a respective imaging device associated therewith, to create an image signal representative only of a card or cards dealt onto the corresponding region.

5. Apparatus according to claim 3 or 4, wherein a single player terminal is associated with each region, whereby each player may use a respective terminal to play a respective hand.

6. Apparatus according to claim 2, 3 or 4, wherein a plurality of player terminals are associated with a region onto which cards may be dealt, whereby a plurality of players may use respective player terminals to play the same hand independently of each other.

7. Apparatus according to any preceding claim, wherein the or each imaging device is located to view the face of a card placed face down on the playing structure.

8. Apparatus according to any preceding claim, wherein the or at least one of the imaging devices is associated with a transparent region of the playing structure, to view the card face through the transparent region.

9. Apparatus according to any preceding claim, wherein the or at least one of the imaging devices is operable to detect the identity of a dealt card and to create an image signal in response to the identity detected.

10. Apparatus according to claim 9, wherein the imaging device is operable to detect machine readable information carried by the card.

11. Apparatus according to claim 10, wherein the machine readable information is a bar code.

12. Apparatus according to claim 10, wherein the machine readable information is information readable by non-optical means.

13. Apparatus according to claim 12, wherein the non-optical means includes a magnetic sensor, inductive coupling or the like.

14. Apparatus according to any preceding claim, wherein the player terminal is operable to display a live video image received from the or the corresponding imaging device.

15. Apparatus according to any preceding claim, wherein the player terminal is operable to receive an image signal identifying one or more cards and to create an image representing those cards for viewing by the player.

16. Apparatus according to any preceding claim, wherein the player terminal has control means operable by a player to place bets relating to the game being played.

17. Apparatus according to any preceding claim, wherein the player terminal has control means operable to send instructions for playing the card or cards being viewed.

18. Apparatus according to any preceding claim, wherein the apparatus maintains a credit score for the or each player, the score being incremented by winnings and decremented by stakes bet by a player.

19. Apparatus according to any preceding claim, wherein the apparatus is operable to record bets placed by a player and further comprises a bet resolution arrangement operable to resolve bets in accordance with the rules of the game being played.

20. Apparatus according to claim 19, comprising dealer control means operable by a dealer to send a signal to the or each player terminal to authorise the or each bet resolution arrangement to resolve bets.

21. Apparatus according to claim 19 or 20, wherein the apparatus is operable to detect the identity of the or each dealt card and to provide the bet resolution arrangement with information relating to the detected identity.

22. Apparatus according to claim 21, wherein the identity is detected by detecting machine readable information carried by the card.

23. Apparatus according to claim 22, wherein the machine readable information is readable by the imaging device.

24. Apparatus according to claim 22, wherein the apparatus incorporates image recognition means operable to detect the identity of a card by an image recognition process.

25. Apparatus according to any preceding claim, comprising a further imaging device associated with the dealer and operable to create an image signal representative of a card dealt to the dealer.

26. Apparatus according to claim 25, comprising control means operable to provide the dealer image signal to the or each player terminal when a dealer hand is to be revealed to one or more other players in accordance with the rules of the game being played, the or each player terminal being operable in response to a dealer image signal to display an image of the dealer card or cards to the player operating the terminal.

27. Apparatus according to any preceding claim, wherein the or at least one player terminal is operable to communicate with the or an imaging device by means of a communication network.

28. Apparatus according to claim 27, wherein the communication network is public.

29. Apparatus according to claim 28, wherein the communication network is the internet.

30. Apparatus according to claim 27, wherein the communication network is private.

31. Apparatus according to claim 30, wherein the communication network is an intranet.

32. Game playing apparatus comprising a playing structure onto which cards may be dealt, and at least one imaging device operable to create an image signal representative of a dealt card, and further operable to send the image signal for receipt by a player terminal.

33. Apparatus according to claim 33, wherein the playing structure is a surface onto which cards are dealt.

34. Apparatus according to claim 33, comprising a plurality of regions on the structure onto which cards may be dealt.

35. Apparatus according to claim 34, wherein each region has a respective imaging device associated therewith, to create an image signal representative only of a card or cards dealt onto the corresponding region.

36. Apparatus according to claim 35, wherein the or each imaging device is located to view the face of a card placed face down on the playing structure.

37. Apparatus according to claim 35 or 36, wherein the or at least one of the imaging devices is associated with a transparent region of the player structure, to view the card face through the transparent region.

38. Apparatus according to claim 35, 36 or 37, wherein the or at least one of the imaging devices is operable to detect the identity of a dealt card and to create an image signal in response to the identity detected.

39. Apparatus according to claim 38, wherein the imaging device is operable to detect machine readable information carried by the card.

40. Apparatus according to claim 39, wherein the machine readable information is a bar code.

41. Apparatus according to claim 39, wherein the machine readable information is information readable by non-optical means.

42. Apparatus according to claim 41, wherein the machine-readable information is readable by a magnetic sensor, inductive coupling or the like.

43. Apparatus according to any of claims 32 to 42, wherein the apparatus maintains a credit score for the or each player, the score being incremented by winnings and decremented by stakes bet by a player.

44. Apparatus according to claim 43, wherein the apparatus is operable to record bets placed by a player and further comprises a bet resolution arrangement operable to resolve bets in accordance with the rules of the game being played.

45. Apparatus according to claim 44, wherein the apparatus being operable to detect the identity of the or each dealt card and to provide the bet resolution arrangement with information relating to the detected identity.

46. Apparatus according to claim 45, wherein the identity is detected, in use, by detecting machine readable information carried by the card.

47. Apparatus according to claim 46, wherein the machine readable information is readable by the imaging device.

48. Apparatus according to claim 46, wherein the apparatus incorporates image recognition means operable to detect the identity of a card by an image recognition process.

49. Apparatus according to any of claims 32 to 48, wherein a further imaging device is associated with the dealer and operable to create an image signal representative of a card dealt to the dealer.

50. Apparatus according to claim 49, further comprising control means operable to provide the dealer image signal to a player terminal when a dealer hand is to be revealed to a player in accordance with the rules of the game being played.

51. Apparatus according to any of claims 32 to 50, wherein the apparatus is operable to send image signals by means of a communication network such as the internet.

52. A player terminal for use in game playing, the terminal being operable to receive an image signal representative of a card dealt in a card game and operable to display an image in response to the image signal for viewing by the player, the player terminal being further operable to receive player decisions relating to the game being played, whereby the player may play the game by viewing and operating the player terminal.

53. A terminal according to claim 52, operable to display a live video image received from the or the corresponding imaging device.

54. A terminal according to claim 52, operable to receive an image signal identifying one or more cards and to create an image representing those cards for viewing by the player.

55. A terminal according to claim 52, 53 or 54, comprising control means operable by a player to place bets relating to the game being played.

56. A terminal according to any of claims 52 to 55, comprising control means operable to send instructions for playing the card or cards being viewed.

57. A terminal according to any of claims 52 to 56, wherein the terminal maintains a credit score for the or each player, the score being incremented by winning sand decremented by stakes bet by a player.

58. A terminal according to claim 57, wherein the terminal records bets placed by a player and further comprises a bet resolution arrangement operable to resolve bets in accordance with the rules of the game being played.

59. A terminal according to any of claims 52 to 58, operable to detect the identity of the or each dealt card and to provide the bet resolution arrangement with information relating to the detected identity.

60. A terminal according to claim 59, comprising image recognition means operable to detect the identity of a card by an image recognition process.

61. A terminal according to any of claims 52 to 60, further operable to receive an image signal representative of a card dealt to a dealer.

62. A terminal according to any of claims 52 to 61, wherein the player terminal is a computer programmed to operate as aforesaid.

63. Computer software which, when installed on a computer system, is operable to provide a player terminal in accordance with any of claims 52 to 62.

64. A method of operating a computer in order to participate in a card game, including:
(i) causing the computer to receive an image signal representative of a card dealt in the card game;
(ii) creating a screen image of the dealt card for viewing by a player;
(iii) responding to instructions input by the user to identify player decisions relating to the game being played.

65. Computer software which, when installed on a computer system, is operable to cause the computer to implement the method.

66. A method of providing a card game for play by players, including:
(i) providing a playing structure onto which cards may be dealt and having at least one imaging device operable to create an image signal representative of a dealt card;
(ii) dealing at least one card onto the playing structure;
(iii) operating the imaging device to provide an image signal; and
(iv) sending the image signal for receipt at a player terminal for use in displaying an image for viewing by a player.

67. A method according to claim 66, wherein the playing structure is a playing structure as defined in any of claims 1 to 31.

68. Game playing apparatus, substantially as described above, with reference to the accompanying drawings.

69. A player terminal, for use in game playing, substantially as described above, with reference to the accompanying drawings.

70. Computer software, substantially as described above, with reference to the accompanying drawings.

71. A method of operating a computer in order to participate in a card game, substantially as described above, with reference to the accompanying drawings.

72. A method of providing a card game for play by players, substantially as described above, with reference to the accompanying drawings.

73. Any novel subject matter or combination including novel subject matter disclosed herein, whether or not within the scope of or relating to the same invention as any of the preceding claims.
